(19) United States
(12) Patent Application Publication
(10) Pub. No.: US 2026/0328240 A1
(43) Pub. Date: Oct. 22, 2026

(54) SCREW, SCREW CONNECTION, AND VEHICLE COUPLING COMPRISING SUCH A SCREW CONNECTION

(71) Applicant: Trailer Dynamics GmbH, Eschweiler (DE)

(72) Inventors: Abdullah JABER, Aachen (DE); Jakob MUSTAFA, Herzogenrath (DE)

(73) Assignee: Trailer Dynamics GmbH, Eschweiler (DE)

(21) Appl. No.: 19/111,407

(22) PCT Filed: Sep. 4, 2023
(86) PCT No.: PCT/EP2023/074213

§ 371 Date: Mar. 13, 2025

(30) Foreign Application Priority Data
Sep. 15, 2022 (DE) 10 2022 123 644.7

(51) Int. Cl. F16B 31/02; B62D 53/08; F16B 25/00

(52) U.S. Cl. CPC F16B 31/025; B62D 53/08; F16B 25/0063

(57) ABSTRACT

The invention relates to a screw (1) comprising a screw head (2) and a screw shaft (3) which has a threaded section B with a thread (6). A measuring device (8) with an extensible measuring strip (9) is arranged along or in the interior of the screw shaft (3). In the process, the extensible measuring strip (9) is arranged in the threaded section B and detects a compression of the screw shaft (8).

The invention relates to a bolt according to the preamble of claim 1 and to a bolted connection having such a bolt and to a vehicle coupling having a corresponding bolted connection.

Bolts with integrated measuring devices, which comprise at least one strain gauge, are used for measuring forces in various usage situations. One usage situation may be the detection of torque during assembly, and another usage situation may be the detection of forces acting on the assembled bolted connection.

DE 10 2020 126 374 A1 discloses a bolt having a measuring device that comprises a strain gauge and is used in particular in vehicle couplings such as fifth-wheel couplings and open-end couplings in order to detect the forces acting on the vehicle coupling while the vehicle is being driven. For this purpose, the strain gauge is positioned in a bore which is formed centrally in the bolt shank and extends from an end remote from the bolt head to the bolt head. The strain gauge is in this case arranged in a bolt-shank portion adjoining the bolt head and is intended to detect an extension of the bolt caused by the forces acting on the bolt.

A bolt of this type functions satisfactorily per se.

The invention is now based on the object of enabling a higher measurement sensitivity.

This object is achieved by a bolt having the features of claim 1, a bolted connection having the features of claim 7 and a vehicle coupling having the features of claim 10. Advantageous configurations are the subject matter of the dependent claims.

In the case of a bolt having a bolt head and a bolt shank which adjoins the bolt head along a bolt axis and has an end facing the bolt head and an end remote from the bolt head, wherein a threaded portion having a thread is formed at least adjacent to the remote end of the bolt shank and a measuring device having a strain gauge is arranged along or in the interior of the bolt shank, it is provided according to the invention that the strain gauge is arranged in the threaded portion and closer to the remote end than to the head-facing end, and detects a compression of the bolt shank, in particular in the direction toward the bolt axis.

Instead of sensing an extension of the bolt or of the bolt shank, as is customary in the prior art, the positioning of the strain gauge in the vicinity of the remote end allows a compression of the bolt shank caused there by the action of force on the thread to be detected. This deformation is several times greater in comparison with extensions of the bolt shank that occur closer to the bolt head given identical tightening torques or tensile forces. This results in a higher measurement sensitivity, as a result of which changes in the compression, which are attributable to changing forces acting on the bolt, can be readily detected.

The strain gauge is in this respect arranged preferably transversely to the longitudinal axis of the bolt. A measurement or detection direction thus lies transversely to the longitudinal axis of the bolt. As a result, it is not, as is customary in the prior art, extensions parallel to the longitudinal axis of the bolt that are detected, but rather a compression transverse to the longitudinal axis of the bolt. This compression is caused by the forces between the thread of the bolt and a mating thread, which lead to a sliding movement between the respective thread flanks and ultimately bring about a compression of the bolt shank.

Preferably, a distance between a start of the thread at the remote end and the strain gauge is 0.5 to 20 times, in particular 0.5 to 10 times or 0.5 to 5 times, a thread pitch of the thread. Compression of the bolt shank occurs most strongly at the outermost thread turns of the thread which are in engagement with a mating thread. With increasing proximity to the bolt head, this compression is increasingly superposed by material extension until there is no compression at all, but only extension. By arranging the strain gauge at the specified distance close to the start of the thread, the influence of the extension is kept low and a high sensitivity is achieved.

In one advantageous refinement, the strain gauge is arranged in the interior of the bolt shank, in particular in a bore, running along the bolt axis from the remote end, of the bolt shank. As a result, the strain gauge is protected from external influences. At the same time, the bolt can be screwed into conventional mating threads.

It is particularly preferable in this case for the bore to extend only over the threaded portion. Alternatively or additionally, the bore can extend preferably over less than ½, in particular less than ⅓ or ¼, of a length of the bolt shank. The mechanical strength and structure of the bolt are thereby substantially maintained. The bolt can therefore absorb and/or transmit high forces.

Advantageously, two electrical connections of the measuring device are arranged in the region of the remote end. These electrical connections can be arranged and designed, for example, in such a way that, when the bolt with sensor capability is being introduced into a socket, they come into contact with two correlating electrical contacts in the socket. In the simplest case, however, the electrical connections can also be led out of the remote end of the bolt shank in the form of cables.

The bolt shank preferably has, adjoining the bolt head, a smooth-walled portion having a constant diameter. The thread thus does not extend over the entire bolt shank. Deformations are thus avoided or reduced.

The bolt preferably has a standard thread, in particular a metric or inch thread. In the case of a metric angle, a flank angle of the thread is, for example, approximately 60°. By means of such a flank angle, sufficient compression of the bolt shank is achieved through the forces acting on the bolt or the bolted connection.

The measuring device preferably comprises signal electronics, which in particular have a quarter bridge, a signal amplifier and a signal converter. As a result, the signal electronics can be connected directly to the strain gauge, such that a virtually loss-free transmission of the analog signal from the strain gauge to the signal electronics is possible, the signal electronics usually generating a processed digital signal therefrom. In this way, even relatively weak output signals can be processed in a reliable and relatively interference-free manner. Furthermore, self-calibration can be effected with low outlay.

The measuring device can also have one or more further sensors, for example a temperature sensor. In this way, temperature-induced measurement errors can be largely prevented and the measurement results can be improved.

The object mentioned at the outset is achieved by means of a bolted connection having a bolt as described above, wherein the thread is in engagement with a mating thread and the strain gauge is arranged in the threaded portion and closer to the remote end than to the head-facing end, and detects a compression of the bolt shank, in particular in the direction of the bolt axis. The mating thread may in this respect be designed, for example, in the form of a nut or may be formed in a corresponding element, such as a fastening flange. As a result of the arrangement of the strain gauge in the threaded portion or in particular in the region in which the thread is in engagement with the thread, compression in the bolt shank and any changes to the bolt shank when the actions of forces change can be readily detected.

In this case, it is particularly preferable for the strain gauge to be positioned in the region of an external threaded engagement. The greatest compressions occur in the region of the external threaded engagement. From there, the compression decreases toward the bolt head. The arrangement of the strain gauge in the region of the external threaded engagement(s) thus enables high sensitivity.

The bolted connection preferably has a socket, which has in particular contact surfaces for electrical connection to the measuring device. Simple and reliable contact connection of the measuring device is thus possible.

The object mentioned at the outset is also achieved by a vehicle coupling, wherein at least one coupling element is fastened via at least one bolted connection configured as described above. The forces occurring between the vehicle and a trailer during operation via the vehicle coupling can thus be reliably detected and evaluated.

It is particularly preferred in this respect for the vehicle coupling to be designed as a fifth-wheel coupling having a kingpin or as an open-end coupling. Such a vehicle coupling can transmit high forces and is thus also suitable for use in heavy commercial vehicles.

Further features, details and advantages of the invention emerge from the wording of the claims and from the following description of exemplary embodiments with reference to the drawings. In the figures:

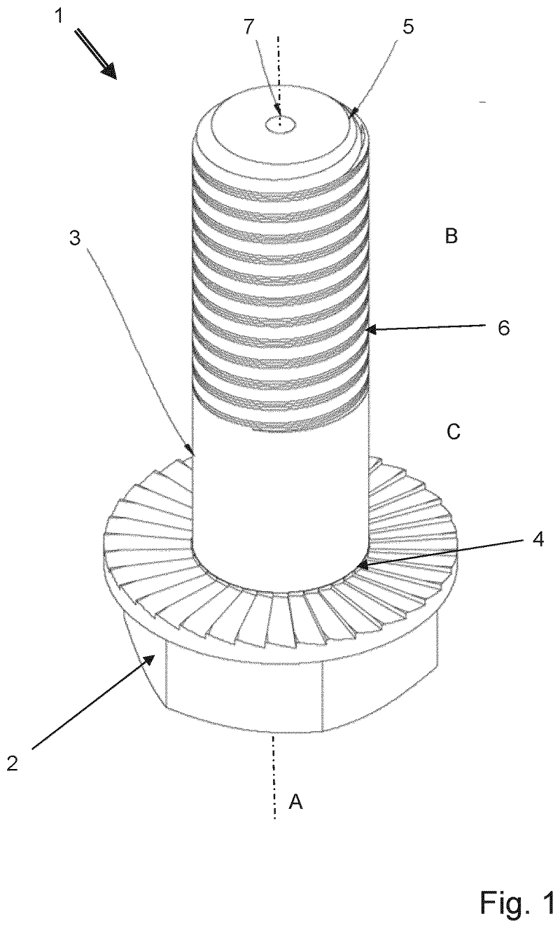

FIG. 1 shows a three-dimensional illustration of a bolt and

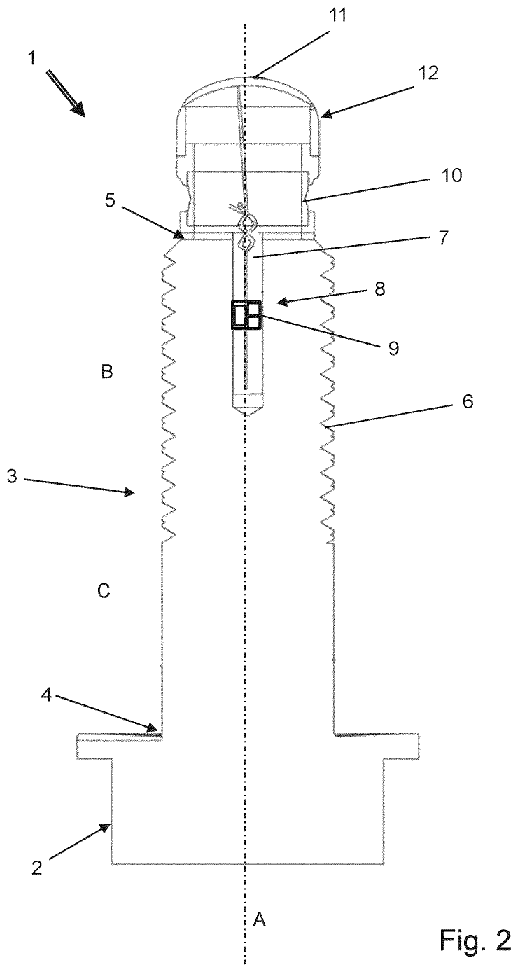

FIG. 2 shows a longitudinal section through a bolt with a measuring device.

FIG. 1 shows a bolt 1 having a bolt head 2 and a bolt shank 3 which extends along a bolt axis A. The bolt shank 3 has an end 4 facing the bolt head 2 and an end 5 remote from the bolt head 2.

Adjacent to the head-remote end 5, the bolt shank 3 comprises a threaded portion B which has a thread 6 and is adjoined by a smooth-walled portion C as far as the bolt head 2.

Proceeding from the remote end 5, a bore 7 extends into the bolt shank 3 along the bolt axis A. It is preferable here for the bore 7 to extend only over the threaded portion, that is to say only part of a length of the bolt shank 3, in order to minimize impairment of the stability and strength of the bolt 1.

FIG. 2 illustrates a longitudinal section through the bolt 1 shown in FIG. 1. A measuring device 8 having a strain gauge 9 is arranged in the bore 7, that is to say in the interior of the bolt shank 3. The strain gauge 9 is in this respect arranged transversely to the longitudinal axis A of the bolt, that is to say detects changes in length that occur transversely to the longitudinal axis A of the bolt. In the event of a compression of the bolt shank 3, the strain gauge 9 is squeezed, which is detected accordingly. Connections 10, 11 of the measuring device are formed in a cap 12, which is placed on the terminal end 5 of the bolt shank 3. Power supply and, if appropriate, also signal transmission can be effected via these connections.

The strain gauge 9 is arranged in the region of the threaded portion B, at the start of the thread beginning at the head-remote end. When the bolt is mounted, the strain gauge 9 therefore lies in the region of an external threaded engagement. The strain gauge thus lies in the region in which maximum compression of the bolt is effected by forces acting along the longitudinal axis of the bolt. This compression is brought about in this case by thread flanks of the bolt thread tending to slip in the direction of the bolt axis on account of the forces acting on thread flanks of a mating thread.

Compared to previously known bolts with sensor capabilities, the bolt according to the invention improves the sensitivity and increases the measurement spectrum. It is possible in this case to detect not only a tightening torque but also tensile loading and strain relief. These properties are particularly advantageous in conjunction with vehicle couplings, with it being possible to control (auxiliary) drives on the basis of the detected forces. For this purpose, the strain gauge is positioned at a position and in an orientation in the bolt at which material compression is particularly pronounced. This position is in the region of the outermost threaded engagement between the bolt thread and a mating thread. A virtually linear relationship between compression and tensile loading is utilized in this respect.

The invention is not restricted to one of the above-described embodiments, but can be modified in a wide variety of ways. Thus, the bolt according to the invention can be used, for example, not only in the region of vehicle couplings for detecting the forces acting thereon, but also, for example, for weight determination or in compression-ignition and internal combustion engines for measuring torques or variable pressures in the engine region. However, other usage situations are also conceivable.

All the features and advantages arising from the claims, the description and the drawing, including structural details, spatial arrangements and method steps, may be essential to the invention both individually and in a wide variety of combinations.

### LIST OF REFERENCE SIGNS

1 Bolt
2 Bolt head
3 Bolt shank
4 Facing end
5 Head-remote end
6 Thread
7 Bore
8 Measuring device
9 Strain gauge
10 Connection
11 Connection
12 Cap
A Bolt axis
B Threaded portion
C Smooth-walled portion

1. A bolt (1) having a bolt head (2) and a bolt shank (3) which adjoins the bolt head (2) along a bolt axis A and has an end (4) facing the bolt head (2) and an end (5) remote from the bolt head (2), wherein a threaded portion B having a thread (6) is formed at least adjacent to the remote end (5) of the bolt shank (3), wherein a measuring device (8) having a strain gauge (9) is arranged along or in the interior of the bolt shank (3), characterized in that the strain gauge (9) is arranged in the threaded portion B and closer to the remote end (5) than to the head-facing end (4) and detects a compression of the bolt shank (3), in particular in the direction toward the bolt axis (A).

2. The bolt as claimed in claim 1, characterized in that a distance between a start of the thread (6) at the remote end (5) and the strain gauge (9) is 0.5 to 20 times, in particular 1 to 10 times, a thread pitch of the thread (6).

3. The bolt as claimed in claim 1, characterized in that the strain gauge (9) is arranged in the interior of the bolt shank (3), in particular in a bore (7), running along the bolt axis A from the remote end (5), of the bolt shank (3).

4. The bolt as claimed in claim 3, characterized in that the bore (7) extends over less than ½, in particular less than ⅓ or ¼, of a length of the bolt shank (3).

5. The bolt as claimed in claim 1, characterized in that two electrical connections (10, 11) of the measuring device (8) are arranged in the region of the remote end (5).

6. The bolt as claimed in claim 1, characterized in that the bolt shank (3) has, adjoining the bolt head (2), a smooth-walled portion C having a constant diameter.

7. A bolted connection having a bolt (1) as claimed in claim 1, characterized in that the thread (6) is in engagement with a mating thread, wherein the strain gauge (9) is arranged in the threaded portion B and closer to the remote end (5) than to the head-facing end (4), and detects a compression of the bolt shank (3), in particular in the direction toward the bolt axis A.

8. The bolted connection as claimed in claim 7, characterized in that the strain gauge (9) is positioned in the region of an external threaded engagement.

9. The bolted connection as claimed in claim 7, characterized in that it has a socket which has in particular contact surfaces for electrical connection to the measuring device (8).

10. A vehicle coupling, wherein at least one coupling element is fastened via at least one bolted connection as claimed in claim 7.

11. The vehicle coupling as claimed in claim 10, characterized in that it is designed as a fifth-wheel coupling having a kingpin or as an open-end coupling.
